(19) United States
(12) Patent Application Publication
(10) Pub. No.: US 2015/0363796 A1
(43) Pub. Date: Dec. 17, 2015

(54) SYSTEM AND METHOD FOR FILTERING SOCIAL MEDIA MESSAGES FOR PRESENTATION ON DIGITAL SIGNAGE SYSTEMS

(71) Applicant: THOMSON LICENSING, Issy de Moulineaux (FR)

(72) Inventors: Scott Arthur Lehman, Foster City, CA (US); Chandra Elcar, San Francisco, CA (US)

(21) Appl. No.: 14/304,153

(22) Filed: Jun. 13, 2014

(51) Int. Cl. G06Q 30/02; G06Q 50/00; G06F 17/30

(52) U.S. Cl. CPC G06Q 30/0201; G06F 17/30699; G06Q 50/01

(57) ABSTRACT

A method for retrieving filtering social media messages from a local retailer's social media accounts. The filtering of social media messages retains localized content for the particular retail location and provides the social media content in a format suitable for display on the retail store's digital signage display devices.

### FIELD OF INVENTION

The present disclosure generally relates to filtering social media feeds in order to deliver social media messages to digital signage systems.

### BACKGROUND

With the prevalence of social media, many retailers have started using social media as an integral part of their marketing campaigns to reach their customers by using targeted and localized content. While customers are in-store, retailers may also constantly engage customers with digital signage systems. However, when retailers want to deliver the same targeted and localized content from their social media feeds to their in-store digital signage systems, it can be very expensive to produce that targeted content on an ongoing basis.

Furthermore, messages that may have been created and intended for social media platforms may not always be suitable for display by an in-store digital signage system. For example, a message may tell customers to “come to our store”, which is not appropriate to display to customers that are already in the store. Social media may also contain URLs/links or other content that is only relevant when the message is being viewed on a web browser or network-connected device. Some social media messages may be too long to be displayed on a digital signage system while using a suitable font size, and other messages may refer to events that happened in the past.

Therefore, there is a need to intelligently filter out such messages to enable a retailer's existing marketing efforts via social media to be used in-store while avoiding the potentially awkward or nonsensical messages that may negatively affect the retailer's image in order to provide more value from the retailer's existing marketing efforts.

### BRIEF SUMMARY

Some embodiments provide a system and method for filtering social media messages for presentation on digital signage systems. Some embodiments provide for receiving account credentials from one or more social media accounts managed by a retailer. Social media content may be retrieved from the various social media accounts managed by the retailer. A filter may then be applied to the retrieved social media content. The filter identifies a set of social media content from the retrieved social media content and will then provide the identified set of social media content in a format compatible with one or more digital signage display devices.

The preceding Summary is intended to serve as a brief introduction to some embodiments of the present disclosure. It is not meant to be an introduction or overview of all inventive subject matter disclosed in this document. The Detailed Description that follows and the Drawings (or “Figures” or “FIGs.”) that are referred to in the Detailed Description will further describe some of the embodiments described in the Summary as well as other embodiments. Accordingly, to understand all the embodiments described by this document, a full review of the Summary, Detailed Description and the Drawings is needed.

### BRIEF DESCRIPTION OF THE DRAWINGS

The novel features of the disclosure are set forth throughout this specification. However, for purpose of explanation, some embodiments are set forth in the following drawings.

FIG. 1 illustrates an exemplary system that may be used to implement some embodiments;

FIG. 2 illustrates a flow chart of an exemplary process used by some embodiments;

FIG. 3 illustrates a flow chart of an exemplary filtering process used by some embodiments;

FIG. 4 illustrates an exemplary software architecture of a project repository application;

FIG. 5 illustrates a flow chart of a exemplary process used by some embodiments to define and store a social media filtering application of some embodiments; and

FIG. 6 illustrates a schematic block diagram of an exemplary computer system with which some embodiments may be implemented.

### DETAILED DESCRIPTION

In the following detailed description, numerous details, examples, and embodiments are set forth and described. However, it will be clear and apparent to one skilled in the art that the disclosure is not limited to the embodiments set forth, and that the disclosed embodiments may be practiced without some of the specific details and examples discussed.

Marketing messages distributed via social media and other channels can be repurposed for digital signage solutions, but intelligent filtering of messages is required so that messages that do not contain relevant content, fail to meet the requirements of the digital signage system, and/or systems that may be rendering the message content into alternate media formats (e.g. video) are ignored. Exemplary messages that may be found on local retailer social media feeds (e.g., Facebook, Twitter, Instagram, etc.) may include sale announcements (graphics and/or video presentations), in store promotions, holiday wishes, free training sessions (e.g., tools, crafts, etc.), employee recognition/promotions for that particular retail location, and user/customer comments/feedback/reviews/photographs/videos/etc.

Since many retailers may already be delivering targeted and/or localized content on their social media platforms, some of the same retailer content, as well as user contributed content, may be repurposed for digital signage systems, either using the text of the social media message directly, or rendering the text and accompanying images into a video or graphical file. However, messages that may have been created and intended for social media platforms may not always be suitable for display by an in-store digital signage system. Therefore, a system and method for intelligently and automatically filtering out such messages may enable a retailer's existing marketing efforts via social media to be used in-store while avoiding the potentially awkward or nonsensical messages.

When a new message is found in a retailer's social media feed (e.g., the potential message), it may be evaluated against a set of rules and requirements before it is deemed acceptable and ingested into the digital signage or related content management system.

A first exemplary approach may be to ensure that a set of criteria is met for a potential message to be ingested. One skilled in the art would understand that several different sets of criteria may be used to decide whether a particular message is acceptable, and that the below criteria are exemplary.

A first criteria check/filter may be to see whether the text of the message is greater than or equal to a minimum length (character count), and less than or equal to a maximum length that is acceptable for displaying on the digital signage system. If a case where an image accompanies the text, a different minimum/maximum criteria may be used since the presence of an image may reduce the amount of space available for text when rendering the message into video or other applicable medium.

Another filtering criteria may analyze the message to see if the message contain text that is not acceptable (e.g. profanity, URLs, or a call to action such as “come to our store” or action that is specific to the social media platform, such as “Like us”). This filtering criteria may be implemented as a set of tests using regular expressions.

A filter may also be provided to check whether the date of the message is too far in the past or announcing a future event that is too far in the future. For example, a message regarding an event one day in the past may not be relevant, and a message conveying an event scheduled for more than one week out from the current date may also be too early for display. When filtering by date of an event, the filter may be set to different parameters for past and/or future events, so that all past event may be filtered out, while some future events (e.g., sale events, promotions, customer activities, in-store trainings) are displayed based on event type and how close the date of the future event will take place.

A further filter may check to see whether the message contain characters that cannot be displayed by the digital signage or rendering system (e.g. non-ASCII content, characters that are not available in the fonts used to display the message, or data that was corrupted due to improper character encodings).

The above filters/checks are meant as exemplary checks. In some cases, these and other filters may be easy and inexpensive to perform, but they still may not be sufficient to detect all undesirable messages. For example, messages with time-sensitive content may still be challenging. For example, if a message is related to a holiday (e.g., “Have a Happy and Safe 4th of July”), it would not be suitable to display after the holiday has passed. Simple filtering of holiday names may be too aggressive, since similar messages (e.g., (“Hope you had a happy 4th of July”) may still be suitable to display after the holiday.

To further improve the filtering process, some embodiments may add a more sophisticated analysis of the messages, such as one or more natural language processing/algorithms, to determine if the content refers to a specific event that has yet to happen or an event that has already happened. Additionally, such inferred knowledge could then be used to instruct the digital signage system that a message with time-sensitive content can only be displayed up to a specific date.

Additionally, more sophisticated measures of a message's length could be used, using knowledge of the width of various characters in a variable-width font and word sizes to determine when a message would be too long to fit using the minimum required font size, or appear unbalanced when the text is flowed across multiple lines.

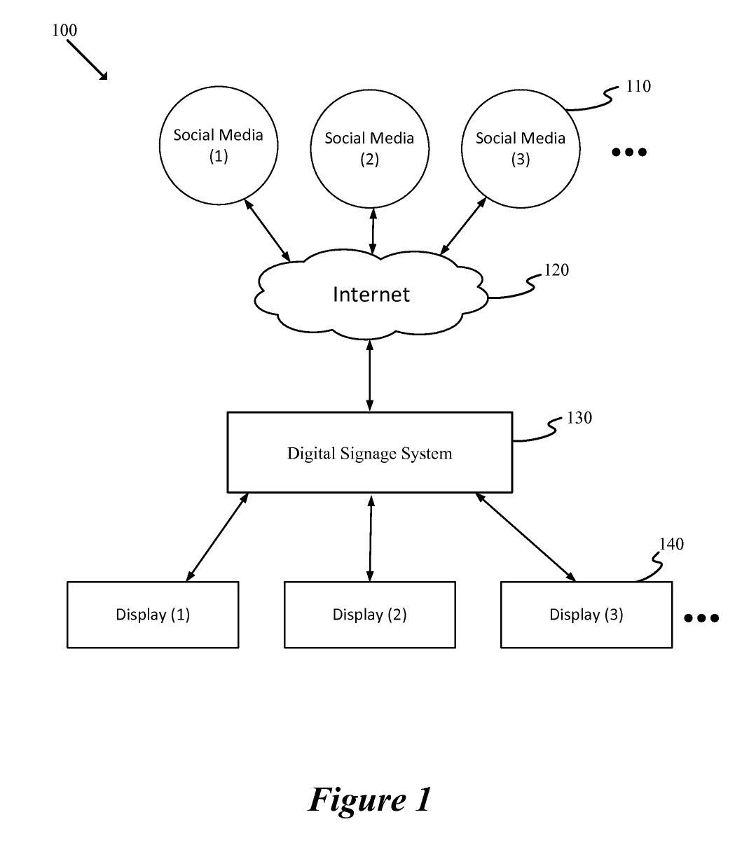

The preceding description illustrates the principles of the present disclosure. Further details, including examples of specific implementation will be provided in reference to FIG. 1-FIG. 6. It will be appreciated that those skilled in the art will be able to devise various arrangements that, although not explicitly described or shown in the subsequent Figures, embody the principles of the disclosure and are included within its scope.

All examples and conditional language recited are intended for informational purposes to aid in understanding the principles of the disclosure and the concepts furthering the art and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herewith represent conceptual views embodying the principles of the disclosure. Similarly, it will be appreciated that any flow charts, diagrams, and the like represent various processes which may be substantially represented in computer readable media and so executed by a computer or processor, whether or not such computer or processor is explicitly shown.

Turning now to FIG. 1, an exemplary system 100 that may be used to implement some embodiments of the present disclosure is provided. As illustrated, the system 100 may include several social media sites 110 that may be accessible via the Internet 120. A retailer's digital signage system 130 may be used to manage content (e.g., video, graphics, text, etc.) to be displayed on various digital display units 140 throughout the retailer's store. The processes described in the present disclosure may be performed at the retailer's digital signage system as shown, while other embodiments may execute the processes at a third party remote server resulting in the delivery of content to the retailer's digital signage system.

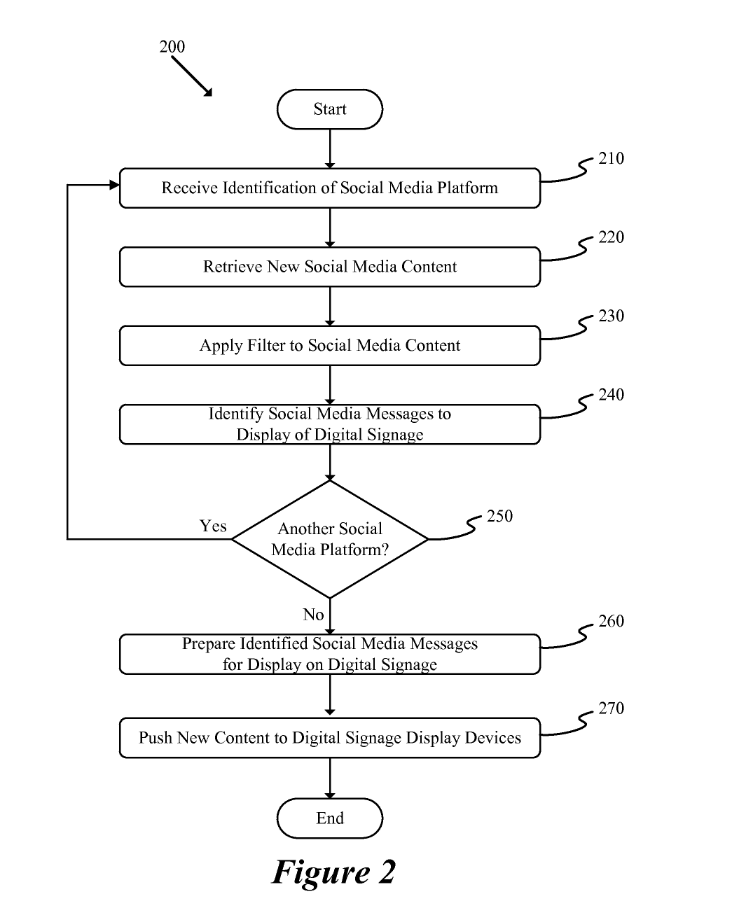

FIG. 2 illustrates a flow chart of an exemplary process used by some embodiments of the present disclosure. The process 200 may begin by receiving (at 210) the identification of a social media platform used by the retailer. The process 200 may then retrieve (at 220) new social media content from the retailer's social media account. This retrieval of content may occur by using several different methods. For example, the retailer's login credential on the social media site may be used to retrieve a social media feed's content or application programming interface instructions provided by the social media website may be used to pull the social media content. Other embodiments may retrieve data from a third party that is responsible for managing the retailer's social network presence. Additionally, some embodiments may use a basic approach of simply “screen scraping” and extracting data from web pages on a social media web sites. In some embodiments, the retrieval of content may only include new content that has been added since the last retrieval of content from the same social media platform.

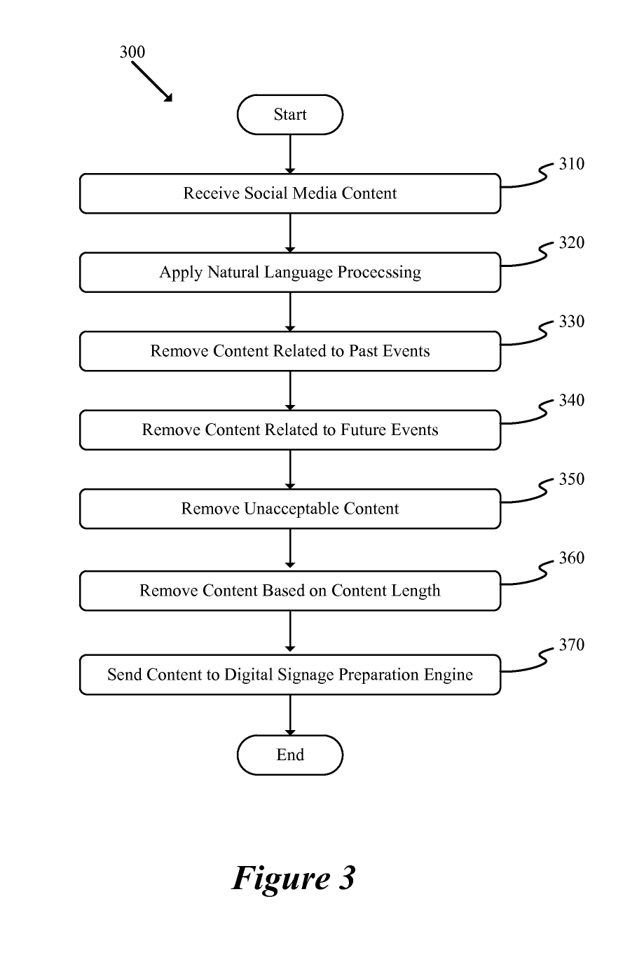

After all new content is retrieved (at 220), the process 200 may then apply (at 230) a filter to the content to remove irrelevant and potentially awkward or nonsensical messages. This step is further discussed with reference to FIG. 3 below. The process 200 will then identify (at 240) a subset of the retrieved social media messages to display on the retailer's digital signage system.

The process 200, may then check (at 250) to see if there is another social media platform owned by the retailer. If another social media platform is identified, via retailer input and/or identification for example, then the process (200) will repeat steps 210 to 240.

If all social media platforms have been checked, the process 200 may then prepare (at 260) the identified social media messages in a format suitable for display on the retailer's digital signage system. Such formats may include video format, graphics format, text format, audio format, and/or any combination thereof. Once the media is prepared (at 260), the process 200 may then push (at 270) the new content to the various digital signage displays within the retailer's store.

FIG. 3 illustrates a flow chart of an exemplary filtering process used by some embodiments, such as the one referenced FIG. 2 at 230. The process 300 may begin by receiving (at 310) social media content from one or more social media platforms. In some embodiments, the process 300 may apply (at 320) a natural language processing to the text of the messages. Such processing may assist in identifying the true intent of a particular message without the need for direct human interaction and/or oversight. In some embodiments, the process 300 may then remove (at 330) content related to past events. This may include holidays messages or sales that already occurred. However, in some instances, winners of past sweepstakes, for example, may still be presented or retained on the digital display device. In such cases, the natural language processing analysis and defined rules of the system may assist in differentiating such messages.

Next, the process 300 may remove (at 340) content related to future events. Various rules may be implemented to dictate which future events messages to remove and/or when to display such messages. For example, some future events may only be displayed starting from a pre-defined number of days before the event will occur, while other future events may have trigger dates or indications for when to display the event and whether the message should be displayed for a few hours, days, or weeks after the trigger event. Such triggers may include words, dates, phrases or a combination thereof. Furthermore, these triggers may also be pre-defined by the retailer so that certain messages, when phrased in a particular manner will cause the process 300 to identify the message and treat it based on a particular set of defined rules and/or filters.

The process 300, may then remove (at 350) unacceptable messages that may be inappropriate for display in a retail store. Such messages may include URLs/links to other content that customers would be unable to select and view on the retailer's digital signage system, or messages requesting customer to visit the store via social media since the customer would already be present at the retail store while viewing similar messages. Other unacceptable messages may be user comments left on the retailer's social media feed that are complaints, negative in nature, or contain inappropriate language. Moreover, unacceptable content may also include non-ASCII content, characters that are not available in the fonts used to display the message, or data that was corrupted due to improper character encodings.

The process 300 may also remove (at 360) content based on the length of the content. For example, content that is too long or not long enough to properly be displayed on the digital signage. Such determinations may consider several factors based on pre-defined rules set by the retailer or automatically generated by the system of the present disclosure. For example, some content may have too many characters or be too long to retain a customer's attention while shopping in a retail environment. Other messages that may be deemed too short may be combined with graphics during the content preparation process (e.g., as described in FIG. 2, 260 and below at 370) to compensate for the length of the message if or when certain messages are deemed to be valuable and/or important (e.g. CEO messages, flash sales, interactive clues for in-store scavenger hunts, etc.) by the system. Once all messages have been thoroughly filtered, the process 300 may send (at 370) the remaining content to the digital signage preparation engine to incorporate the social media messages into relevant marketing campaign videos, graphics, text, or any combination thereof.

Some embodiments may also allow for a manager of the retail location to review the filtered social media content for final approval before or after the rendering step occurs. This may allow a double check to ensure that the automatic filtering criteria is performing properly and that no unacceptable messages may accidently pass through the filtering process.

One of ordinary skill in the art will recognize that processes 200 and 300 may be performed in various appropriate ways without departing from the scope of the disclosure. For instance, the process may not be performed as one continuous series of operations in some embodiments. In addition, the process may be implemented using several sub-processes (e.g. FIG. 3), or as part of a larger macro-process (e.g. FIG. 2). Furthermore, various processes may be performed concurrently, sequentially, or some combination of sequentially and concurrently. Moreover, the operations of the process may be performed in different orders.

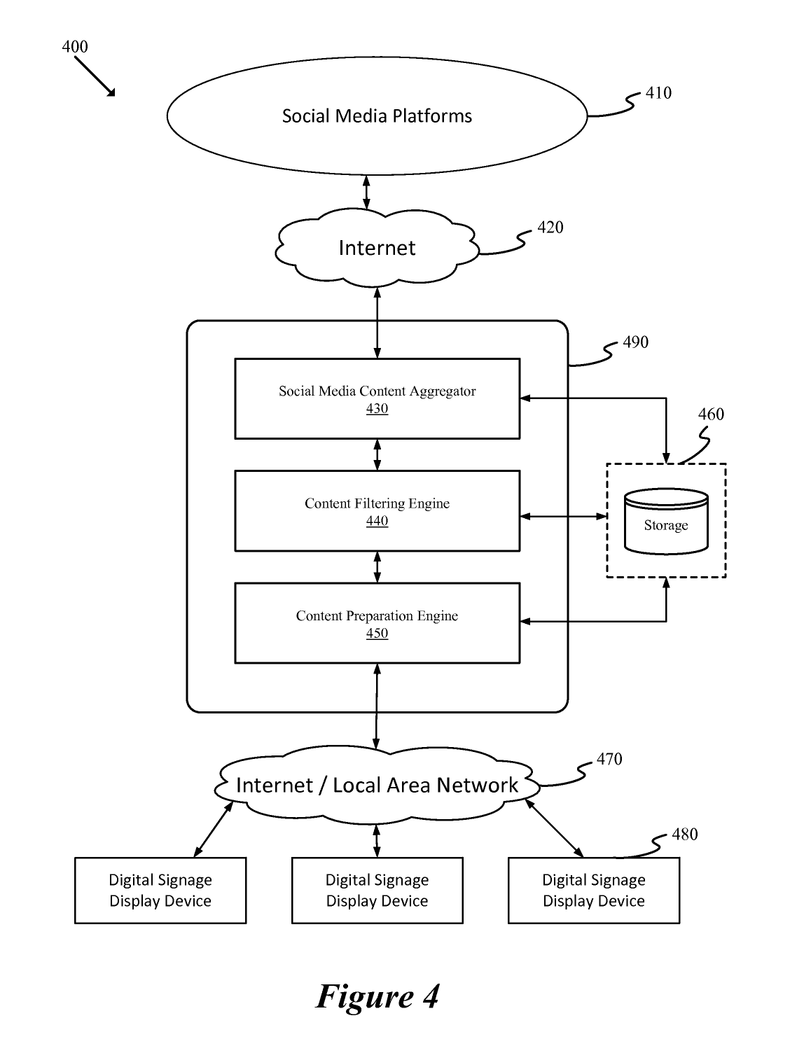

In some embodiments, the above-described operations may be implemented as software running on a particular machine such as a server, desktop computer, laptop, or handheld device (e.g. smartphone or tablet), or as software stored in a computer readable medium. FIG. 4 illustrates an exemplary block diagram of a system 400 for implementing an application 490 for filtering social media messages for presentation on digital signage systems. As illustrated, the application 490 may connect to several social media platforms 410 via the Internet 420. The application 490 may include several modules including, but not limited to, a social media content aggregator 430, a content filtering engine 440, and a content rendering engine 450. All these modules may be communicatively coupled to storage 460 where content for the digital signage display devices 480 may be stored. The storage 460 may be local storage found at the retailer's place of business, while other embodiments may provide the storage 460 via a remote location such as a private or public cloud infrastructure.

The social media content aggregator 430 may be responsible for connecting to all the various social media platforms managed and owned by a particular retail store. The aggregator 430 may pull all messages and/or media content (e.g., videos, photographs, graphics, etc.) from the retailer's social feeds and store them in storage 460. The social media content aggregator 430 may periodically check all the maintained social media sites at pre-determined intervals or update on the fly to capture new messages that may potentially be useful in marketing or informational purposes within the retail stores.

The content filtering engine 440 will parse through all the messages received by the aggregator to identify all relevant and useful messages and content that may potentially be displayed on the digital signage devices 480 throughout the retailer's store. Exemplary filtering techniques were provided by reference to FIG. 3. The identified message may be flagged in the storage 460 or stored in a different database altogether. The content rendering engine 450 may be responsible for taking the relevant messages and content identified by the content filtering engine 440 and rendering the messages into one or more suitable formats for display on the retailer's digital signage display devices 480. The final rendering content for display may also be stored in storage 460.

Finally, the content rendering engine 450, or alternatively the storage 460, may push the rendered content to the retailer's digital signage devices 480. In some embodiments, the rendered content may be sent to the retailer's digital signage devices 480 via the Internet, while other embodiments may use a local or private local area network to distribute the rendered content to the display devices 480. In some embodiments, the application 490 may send different content to different display devices rather that blanketing all displays with the same content. For example, particular department may receive content relevant to that department while other departments may not receive such content, while other global content that may be relevant to the entire retail store is sent to all digital signage devices 480 throughout the retailer's store.

It should be recognized by one of ordinary skill in the art that any or all of the components of software application 490 may be used in conjunction with the present disclosure. Moreover, one of ordinary skill in the art will appreciate that many other configurations may also be used in conjunction with the present disclosure or components of the present disclosure to achieve the same or similar results.

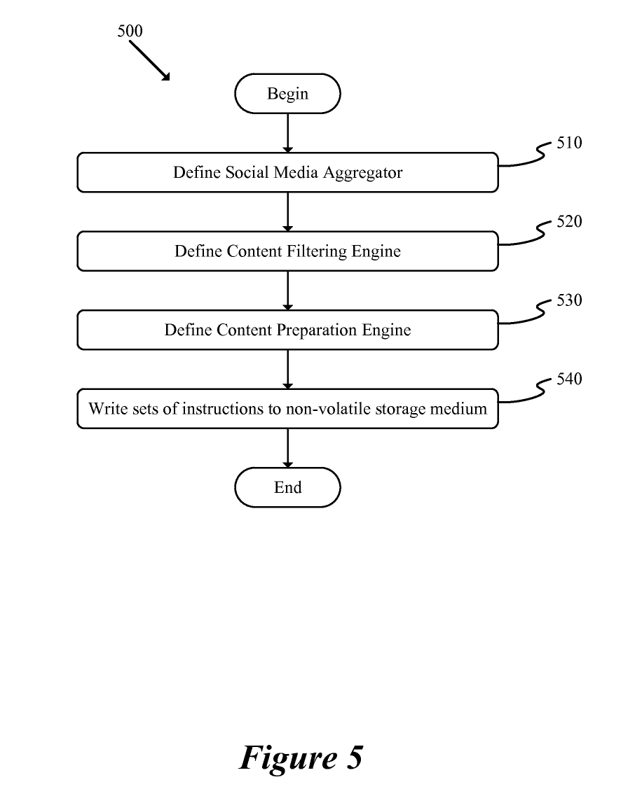

FIG. 5 illustrates a flow chart of an exemplary process 500 used by some embodiments to define and store a social media filtering application of some embodiments. Specifically, process 500 illustrates the operations used to define sets of instructions for providing several of the elements described above in FIG. 4.

As shown, the process 500 may define (at 510) sets of instructions for implementing a social media content aggregator (e.g., as described above in reference to FIG. 4). In some cases such sets of instructions are defined in terms of object-oriented programming code. For example, some embodiments may include sets of instructions for defining classes and instantiating various objects at runtime based on the defined classes.

Next, process 500 defines (at 720) sets of instructions for a content filtering engine. Process 500 then defines (at 530) sets of instructions for a content rendering engine. Finally, the process writes (at 540) the sets of instructions to a storage medium such as, but not limited to, a non-volatile storage medium.

One of ordinary skill in the art will recognize that the various sets of instructions defined by process 500 are not exhaustive of the sets of instructions that could be defined and stored on a computer readable storage medium for a social media filtering application incorporating some embodiments of the disclosure. In addition, the process 500 is an exemplary process, and the actual implementations may vary. For example, different embodiments may define the various sets of instructions in a different order, may define several sets of instructions in one operation, may decompose the definition of a single set of instructions into multiple operations, etc. In addition, the process 500 may be implemented as several sub-processes or combined with other operations within a macro-process.

Many of the processes and modules described above may be implemented as software processes that are specified as at least one set of instructions recorded on a non-transitory storage medium. When these instructions are executed by one or more computational elements (e.g., microprocessors, microcontrollers, Digital Signal Processors (“DSPs”), Application-Specific ICs (“ASICs”), Field Programmable Gate Arrays (“FPGAs”), etc.) the instructions cause the computational element(s) to perform actions specified in the instructions.

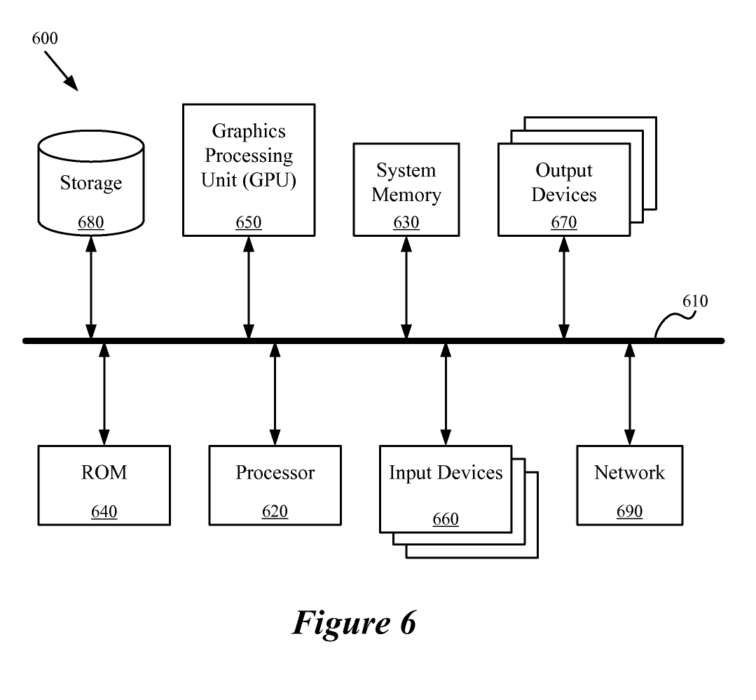

FIG. 6 illustrates a schematic block diagram of a computer system 600 with which some embodiments of the disclosure may be implemented. For example, the system described above in reference to FIG. 4 may be at least partially implemented using computer system 600. As another example, the processes described in reference to FIG. 2 and FIG. 3 may be at least partially implemented using sets of instructions that are executed using computer system 600.

Computer system 600 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 600 may include a bus 610, at least one processing element 620, a system memory 630, a read-only memory (“ROM”) 640, other components (e.g., a graphics processing unit) 650, input devices 660, output devices 670, permanent storage devices 680, and/or a network connection 690. The components of computer system 600 may be electronic devices that automatically perform operations based on digital and/or analog input signals.

Bus 610 may represent all communication pathways among the elements of computer system 600. Such pathways may include wired, wireless, optical, and/or other appropriate communication pathways. For example, input devices 660 and/or output devices 670 may be coupled to the system 600 using a wireless connection protocol or system. The processor 620 may, in order to execute the processes of some embodiments, retrieve instructions to execute and data to process from components such as system memory 630, ROM 640, and permanent storage device 680. Such instructions and data may be passed over bus 610.

ROM 640 may store static data and instructions that may be used by processor 620 and/or other elements of the computer system. Permanent storage device 680 may be a read-and-write memory device. This device may be a non-volatile memory unit that stores instructions and data even when computer system 600 is off or unpowered. Permanent storage device 680 may include a mass-storage device (such as a magnetic or optical disk and its corresponding disk drive).

Computer system 600 may use a removable storage device and/or a destination storage device as the permanent storage device. System memory 630 may be a volatile read-and-write memory, such as a random access memory (“RAM”). The system memory may store some of the instructions and data that the processor uses at runtime. The sets of instructions and/or data used to implement some embodiments may be stored in the system memory 630, the permanent storage device 680, and/or the read-only memory 640. For example, the various memory units may include instructions for authenticating a client-side application at the server-side application in accordance with some embodiments. Other components 650 may perform various other functions. These functions may include interfacing with various communication devices, systems, and/or protocols.

Input devices 660 may enable a user to communicate information to the computer system and/or manipulate various operations of the system. The input devices may include keyboards, cursor control devices, audio input devices and/or video input devices. Output devices 670 may include printers, displays, and/or audio devices. Some or all of the input and/or output devices may be wirelessly or optically connected to the computer system.

Finally, as shown in FIG. 6, computer system 600 may be coupled to a network through a network adapter 690. For example, computer system 600 may be coupled to a web server on the Internet such that a web browser executing on computer system 600 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 600 may be used in conjunction with the disclosed embodiments. Moreover, one of ordinary skill in the art will appreciate that many other system configurations may also be used in conjunction with the disclosed embodiments or components of the embodiments.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the disclosure has been described with reference to numerous specific details, one of ordinary skill in the art will recognize that the disclosure can be embodied in other specific forms without departing from the scope of the disclosure. For example, several embodiments were described above by reference to particular features and/or components. However, one of ordinary skill in the art will realize that other embodiments might be implemented with other types of features and components, and that the disclosure is not to be limited by the foregoing illustrative details.

What is claimed is:

1. A method comprising:
receiving account credentials for a retailer's social media account;
retrieving social media content from the retailer's social media account;
applying a filter to the social media content; and
identifying a set of social media content from the retrieved social media content based on the filtering.

2. The method of claim 1 further comprising:
preparing the identified set of social media content to be compatible with one or more digital signage display devices; and
sending the prepared social media content to the digital signage display devices in the retailer's store.

3. The method of claim 1, wherein the receiving of account credentials comprises a plurality of account credentials for two or more social media accounts owned by the retailer.

4. The method of claim 1, wherein the filter processes the social media content with natural language processing.

5. The method of claim 1, wherein the filter removes unacceptable social media content not suitable for display on the retailer digital signage display devices by evaluating the social media content against a set of rules defined by the retailer.

6. The method of claim 5, wherein the set of rules may include trigger words found in the social media content.

7. The method of claim 1 further comprising sending the identified social media content to the retailer's manager for approval to display the social media content throughout the retailer's location.

8. An apparatus for creating a location scouting tool comprising:
a storage for storing social media content from a retailer's one or more social media accounts;
a memory for storing sets of instructions;
a processor for executing the sets of instructions, wherein the processor:
receives account credentials for a retailer's social media account;
retrieves social media content from the retailer's social media account;
applies a filter to the social media content; and
identifies a set of social media content from the retrieved social media content based on the filtering.

9. The apparatus of claim 8, wherein the memory further comprises sets of instructions for applying natural language processing to the social media content.

10. The apparatus of claim 9, wherein the memory further comprises sets of instructions for removing social media content based on the natural language processing and a set of rules for flagging unacceptable social media content.

11. The apparatus of claim 8, wherein the memory further comprises sets of instructions for preparing, for display, the identified set of social media content to be compatible with one or more digital signage display devices

12. The apparatus of claim 8, wherein the memory further comprises sets of instructions for defining a frequency for retrieving new social media content from one or more social media accounts.

13. The apparatus of claim 8 further comprising a network connection for transmitting the social media content to the storage.

14. A non-transitory computer readable medium storing a repository application for execution by at least one processor, the repository application comprising sets of instructions for:
defining a social media content aggregator for retrieving social media content from one or more social media accounts managed by a retail store;
defining social media content filtering engine for automatically filtering the social media content so only relevant social media content to the retail store's location is output; and
defining a content preparation engine for packaging the output of the social media content filtering engine into a format that is compatible with a retail digital signage system.

15. The non-transitory computer readable storage medium of claim 14, wherein the social media filtering engine process social media content retrieved by the social media content aggregator using a natural language processing algorithm.

16. The non-transitory computer readable storage medium of claim 14, wherein the social media filtering engine removes social media content related to past events.

17. The non-transitory computer readable storage medium of claim 15, wherein the social media filtering engine removes content based on a set of triggers defined by the retailer.

18. The non-transitory computer readable storage medium of claim 14, wherein the social media filtering engine removes content that is not compatible with the digital signage system of the retailer.

19. The non-transitory computer readable storage medium of claim 14, wherein the social media filtering engine removes social media content containing links to external websites.

20. The non-transitory computer readable storage medium of claim 14, wherein the social media filtering engine removes requests for customer online actions.
